(19) United States
(12) Patent Application Publication
(10) Pub. No.: US 2026/0167316 A1
(43) Pub. Date: Jun. 18, 2026

(54) PROTECTION FOR AN AIRCRAFT FUSELAGE

(71) Applicant: Airbus Operations GmbH, HAMBURG (DE)

(72) Inventors: Hermann BENTHIEN, HAMBURG (DE); Martin SIEMANN, HAMBURG (DE)

(21) Appl. No.: 19/407,745

(22) Filed: Dec. 3, 2025

(30) Foreign Application Priority Data
Dec. 18, 2024 (EP) 24221111.8

(51) Int. Cl. B64C 1/14; B64D 45/00; B64F 5/40

(52) U.S. Cl. CPC B64C 1/14; B64D 45/00; B64F 5/40

(57) ABSTRACT

Protection for an aircraft fuselage being as light as possible and which is easily integrated into the fuselage is provided as a protective insert for an aircraft tail area. The protective insert has a protective panel, an absorption body supporting the protective panel, and a force transmission device holding the absorption body. The protective panel is configured for pressure-loaded sliding contact with a runway during a tail impact. The protective panel transfers compressive force acting during the tail impact to the absorption body. The absorption body is configured to absorb the compressive force in a force-damping manner, wherein part of the energy due to the acting compressive force is convertible into an elastic and/or plastic deformation of at least a part of the absorption body. The force transmission device holds the protective insert on the underside of the tail area of an aircraft via a plurality of fastening areas.

### CROSS-REFERENCES TO RELATED APPLICATIONS

This application claims the benefit of European Patent Application Number 24221111.8 filed on Dec. 18, 2024, the entire disclosure of which is incorporated herein by way of reference.

### FIELD OF THE INVENTION

The present invention relates to protection for an aircraft fuselage, for example in the event of a tail strike. The present invention relates, in particular, to a protective insert for the tail area of an aircraft, to a protective system for the tail area of an aircraft, and to an aircraft.

### BACKGROUND OF THE INVENTION

During takeoff or landing, aircraft may accidentally touch or come into contact with the runway, for example, if the aircraft is at an angle too steep in relation to the runway. Contact with the runway surface can occur with varying degrees of force on the tail area of the fuselage. This contact is also referred to as a tail impact. Protective measures may be provided to protect the fuselage. For example, a tailskid may be provided on the underside of the fuselage. The tail skid may be designed as a drag skid or a small skid wheel, for example. Reinforcements to the structure may also be provided for protection. For example, DE 19848122 A1 describes a protective device for the rear of an aircraft fuselage in which a reinforcement frame transfers the load to the fuselage structure. However, protective measures, especially in commercial passenger aircraft, usually involve additional weight and/or considerable design effort.

### SUMMARY OF THE INVENTION

An object of the present invention is therefore to provide a protective measure that is as light as possible and that can be easily integrated into the fuselage.

The aspects described in the following apply to the protective insert for a tail area of an aircraft, to the protective system for a tail area of an aircraft, to the aircraft, and to the method for protecting an aircraft fuselage, as well as to the use of a protective insert for a tail impact of an aircraft.

According to the invention, a protective insert for a tail area of an aircraft is provided. The protective insert has a protective panel, an absorption body supporting the protective panel, and a force transmission device holding the absorption body. The protective panel is designed (also meaning configured) for pressure-loaded sliding contact with a runway in the event of a tail impact. The protective panel transfers a compressive force acting during the tail impact to the absorption body. The absorption body is designed to absorb the compressive force in a force-damping manner, wherein part of the energy due to the acting compressive force can be converted into an elastic and/or plastic deformation of at least a part of the absorption body. The force transmission device is designed to hold the protective insert on the underside of the tail area of an aircraft and has a plurality of fastening areas.

A tail strike area that is replaceable allows for quick and easy replacement of the structure affected by a tail strike. A tail strike area that is replaceable allows for integration of the tail strike area so that this area can be replaced without aircraft-specific tolerances.

According to an aspect, a new design principle for a shock-absorbing function in a standard fuselage is provided.

The hull panel can be used for reinforcement in a form-fitting manner.

According to an aspect, the force is introduced into an insert and partially absorbed there by deformation of the insert or its material structure, and then damped and distributed evenly. The insert therefore serves, on the one hand, to introduce and evenly distribute the force and, on the other hand, also to dampen it.

The insert is designed and configured in such a way that a form-fitting connection is still guaranteed even if the rear end touches down and deformation occurs. The integrity of the form-fitting force transmission is always maintained.

In an example, the insert is held in a frame, respectively a receptacle in a form-fitting manner.

In another example, the receptacle is held in a form-fitting manner in a frame of the supporting structure, for example between frames and stringers.

In yet another example, both the insert and the receptacle are held in a form-fitting manner.

According to an aspect, it is provided that an unwanted force acting on the tail area, for example when the rear touches down during landing, is not transmitted directly to the structure of the fuselage, but is absorbed by a damping element, i.e., transmitted in a damped manner. The damping element is designed and configured, for example, as a replaceable protective insert and serves to absorb the force occurring at a specific point and transmit it to, for example, a surface, in order to then introduce the force into the fuselage structure via a frame.

The protective insert can, for example, have a round shape, an oval or elliptical shape, or even a rectangular shape.

According to an example, the absorption body comprises an absorption insert having a material structure with a plurality of cavities. At least a part of the energy can be absorbed by elastic and/or plastic deformation of the material structure due to the acting compressive force. The material structure is designed as at least one from the group comprising: foam structure, lattice structure, and foam-like fabric.

According to an example, the absorption body is formed cushion-like and has an envelope or cover in which a filling is provided. The cover is held on the force transmission device and forms a first side against which the protective panel abuts and a second side facing away from the first side. The filling is designed and configured to transfer a compressive force transmitted by the protective panel on the first side to the second side of the cover, so that the force can be transferred via the second side of the cover as a tensile force to the force transmission device.

According to an example, the filling is designed as an absorption filling, and at least a part of the energy due to the acting compressive force can be absorbed by elastic and/or plastic deformation of the absorption filling.

According to an example, the absorption filling is designed as an absorption insert having a material structure with a plurality of cavities. At least a part of the energy due to the acting compressive force can be absorbed by elastic and/or plastic deformation of the material structure. The material structure is designed as a foam structure, lattice structure, or foam-like fabric, or a combination of this group, for example, foam structure/lattice structure, foam structure/foam-like fabric, grid structure/foam-like fabric, or foam structure/lattice structure/foam-like fabric.

According to an example, the protective panel comprises a composite material comprising a matrix and reinforcement fibers embedded in the matrix, wherein at least a part of the reinforcement fibers comprises S-glass.

According to an example, the protective insert has a thermal insulation that reduces heat input from the outer protective panel toward the interior of the fuselage.

According to the invention, also a protective system for a tail area of an aircraft is provided. The protective system has a protective insert according to one of the preceding examples and a receiving frame. The receiving frame is configured to receive the protective insert and to transfer the forces acting on the receiving frame via the protective insert into a fuselage structure of an aircraft. The mounting frame has a receptacle for the protective insert and a plurality of connection points for attachment to supporting elements of the fuselage structure.

According to an example, the protective insert is openable when the receiving frame is installed. The receiving frame is designed to form an access opening to the interior of the hull when the protective insert is openable or removed for inspection, maintenance, and/or repair purposes.

According to an aspect, a so-called manhole plate has a dual function. In a first function, the plate serves to close an opening to allow access to the interior of the fuselage by allowing a person to pass through the opening. In a second function, the plate serves to protect against tail strikes.

The plate, also referred to as an insert, can be load-bearing during normal operation, i.e., for flight and ground load cases, and can be designed to allow for advantageous load transfer in the event of a tail strike. For example, the load is transferred from the impact area of the tail strike to the surrounding fuselage structure, so that any damage may occur in the impact area of the tail strike, wherein the impact area may be replaceable.

A defined area for a tail impact is formed as part of the manhole plate. The tail impact protection is therefore provided in a designated area of the fuselage. This enables the following properties and avoids an aircraft-specific repair solution after a tail impact.

For example, the fastenings of the protective insert, i.e., the manhole cover, remain functional even after (limited) plastic deformation, e.g., due to a tail impact.

For example, the fastenings of the manhole cover perform a sealing function. The manhole cover can optionally include a thermal insulation function to protect the hydrogen tanks from thermal influences, e.g., due to a tail impact.

According to an example, the receiving frame is provided in a fuselage panel that is designed as a removable structural panel to allow larger components, including hydrogen tanks, segments of hydrogen tanks, and systems and components of systems for hydrogen tanks and hydrogen propulsion, to be installed and removed within the fuselage.

According to the invention, also an aircraft is provided. The aircraft has a fuselage and wings attached to the fuselage, as well as a tail unit attached to the fuselage. The fuselage has a tail area. A protective system according to one of the preceding examples is provided on the underside of the tail area.

In addition, also a method for protecting an aircraft fuselage and a use of a protective insert for a tail impact of an aircraft are provided.

According to an aspect, the force is introduced into an insert and partially absorbed there by deformation of the insert or its material structure, and then damped and distributed evenly. The insert thus serves, on the one hand, to introduce and evenly distribute the force and, on the other hand, to dampen it.

According to an aspect, the protective insert is designed as an absorption cushion formed by two outer shell surfaces and a filling in order to transfer the impact force from one shell surface to the other via the filling. The impact force acting as a compressive force on one shell surface is converted by the filling into a force that acts as a tensile force on the other shell surface. The tensile force can be distributed evenly to a frame via the other shell surface.

In the event of an impact, the second side of the envelope acts as a tension-loaded membrane. The resulting membrane tension is transferred to the frame.

The protective insert is formed by a flexible core in a shell with a cover on the outside.

It should be noted that the features of the embodiments of the protective insert for a tail area of an aircraft also apply to embodiments of the protective system for a tail area of an aircraft, of the aircraft, and of the method for protecting an aircraft fuselage, and vice versa. In addition, those features that are not explicitly mentioned can also be freely combined with each other.

### BRIEF DESCRIPTION OF THE DRAWINGS

The following describes the embodiments of the invention in more detail with reference to the accompanying drawings.

FIG. 1 schematically shows an example of a protective insert for the tail area of an aircraft.

FIG. 2 schematically shows another example of a protective insert.

FIG. 3 schematically shows an example of a protective system for the tail area of an aircraft.

FIG. 4 shows an example of the protection system on an aircraft tail in a side view.

FIG. 5 shows the example of the protection system of FIG. 3 in a vertical section through the rear of the aircraft.

FIG. 6 shows another example of the protection system on an aircraft tail in a side view.

FIG. 7 shows the example of the protection system of FIG. 5 in a vertical section through the rear of the aircraft.

FIG. 8 schematically shows an example of an aircraft in a side view in connection with a runway.

### DETAILED DESCRIPTION OF THE PREFERRED EMBODIMENTS

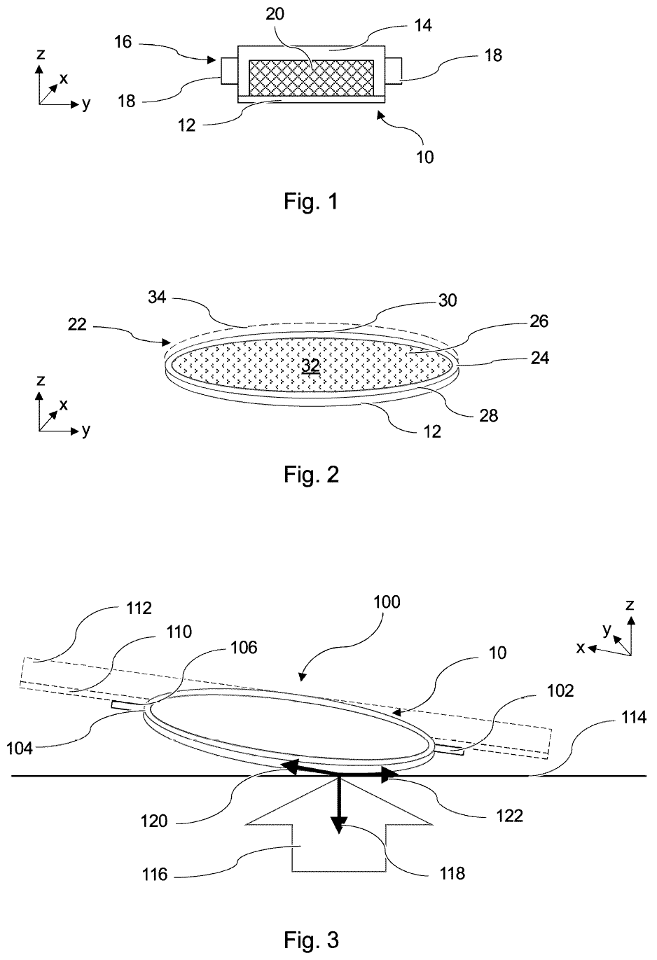

FIG. 1 schematically shows an example of a protective insert 10 for a tail area of an aircraft. The protective insert 10 has a protective panel 12, an absorption body 14 supporting the protective panel, and a force transmission device 16 holding the absorption body. The protective panel 12 is designed for pressure-loaded sliding contact with a runway in the event of a tail impact. The protective panel 12 transfers a pressure force acting during the tail impact to the absorption body 14. The absorption body 14 is designed to absorb at least a part of the pressure force by force-damping. A part of the energy due to the acting compressive force can be converted into an elastic and/or plastic deformation of at least a part of the absorption body 14 in an absorbing manner. The force transmission device 16 is designed to hold the protective insert 10 on an underside of a tail area of an aircraft and has a plurality of fastening areas 18.

In FIG. 1, an example of the protective insert is shown in a cross-section, for example analogous to a fuselage cross-section in a later installation situation.

The term “protective insert” refers to a component that is intended as a protective measure against tail strikes at the rear of the aircraft.

The term “protective panel” refers to a protection for the body behind it. The protective panel 12 is a plate-like component that can have a curved contour, for example, single or double curved. The protective panel 12 is located on the outside of the fuselage to be protected.

The protective insert 10 can also be referred to as a protective panel. The above-mentioned protective panel 12 would then be a protection or protective attachment.

The term “absorption body” refers to the main component of the protective insert 10 for at least partially absorbing an impacting force, for example when the tail touches down on the runway. The absorption body 14 can also be referred to as an absorption core or absorption structure.

The term “force transmission device” refers to a retaining device that is also designed to transfer the non-absorbed portion of the force.

The tail impact refers to a generally undesirable impact or collision of the tail of the aircraft. The tail impact is also referred to as tail strike.

The force acting on the fuselage during a tail impact has a horizontal component resulting from the forward movement of the aircraft in relation to the runway. This forward movement is counteracted by the frictional force generated by the contact between the protective panel 12 and the surface of the runway. The force acting on the fuselage during a tail impact also has a vertical component resulting from the relative downward movement of the tail in relation to the runway. The downward movement with a tail strike can occur, for example, if the aircraft has an angle too large in relation to the runway during landing, or if it is brought into an angle too large in relation to the runway during takeoff.

The protective panel 12 is designed to for the sliding or rubbing along the runway. The protective panel 12 is therefore preferably designed with a friction-resistant surface. In addition to being suitable for minimizing material abrasion, the protective panel 12 is also designed to withstand high temperatures that can arise due to strong friction. The strong friction results, for example, from a relatively high speed and relatively high pressure.

The absorption effect means that vertical decelerations in the event of a tail impact are transmitted to the aircraft structure to a lesser extent. This has a particularly favorable effect on hydrogen tanks on board the aircraft.

In an example, the protective insert 10 is round. In another example, the protective insert 10 is oval or elliptical. In yet another example, the protective insert 10 is rectangular or polygonal.

As an option, FIG. 1 shows that the absorption body 14 comprises an absorption insert 20 having a material structure with a plurality of cavities. At least a part of the energy can be absorbed by elastic and/or plastic deformation of the material structure due to the acting compressive force. The material structure is designed as at least one of the group comprising: foam structure, lattice structure, and foam-like fabric.

The term “absorption insert” refers to a part of the absorption body 14 that is intended for absorption. The absorption insert 20 can be inserted into a retaining structure or designed as a separate body.

The material structure is characterized by a plurality of relatively small connection areas. These connection areas can be elastically deformed to a certain extent, and the connection areas can also be plastically deformed. Due to the large number of connection areas, a relatively large compressive force acting on the absorption insert 20 can be converted into deformation energy, and thus absorbed.

In an example, the material structure can be elastically deformed and returns to its initial state after the forces are removed. In another example, the material structure can be plastically deformed and does not return to its initial state after the forces are removed. In a further example, the material structure can be elastically and plastically deformed and does not completely return to its initial state after the forces are removed.

During the elastic and/or plastic deformation of the material structure, the impact energy is converted into deformation energy. This leads to a reduced transfer of the impact impulse to the hull structure.

FIG. 2 shows a schematic diagram of another example of the protective insert 10. The absorption body 14 is designed as a kind of cushion 22 and has an envelope or cover 24 in which a filling 26 is provided. The envelope is held by the force transmission device 16 (not shown) and forms a first side 28, against which the protective panel abuts, and a second side 30 facing away from the first side. The filling 26 is designed to transfer a compressive force transmitted by the protective panel 12 on the first side 28 to the second side 30 of the cover 24, so that the force can be transferred via the second side 30 of the cover 24 as a tensile force to the force transmission device 16.

The term “cushion-like” refers to a type of absorption filling 32 in an envelope that holds the filling.

The term “envelope” refers to a structure surrounding the absorption filling 32. The envelope may be formed as a membrane or as a net. The envelope serves to absorb and dissipate forces.

The term “filling” refers to the insert or body in the envelope. The filling can be a self-supporting structure or be held by the envelope.

The cushion shape is particularly suitable for the spherical area of the underside of the fuselage at the rear of the aircraft.

As an option, FIG. 2 shows that the filling 26 is designed as an absorption filling 32 and that at least a part of the energy due to the acting compressive force is absorbable through elastic and/or plastic deformation of the absorption filling 32.

In an option, the absorption filling 32 is designed as an absorption insert that has a material structure with a plurality of cavities. At least a part of the energy can be absorbed by elastic and/or plastic deformation of the material structure due to the pressure force acting on it. The material structure is designed as a foam structure and/or lattice structure and/or foam-like fabric.

The term “absorption filling” refers to a structure that absorbs or dampens at least a part of the force when an impact force is applied, for example in the event of a tail strike.

The design of an absorbent cushion provides a fluid-supported membrane support element that transmits an impact force in a damped manner. For example, the impact force is transmitted to the aircraft's supporting structure, i.e., the fuselage structure, in a damped or even reduced form.

In an option, for example, the protective panel 12 not only provides protection against contact with the runway, but also performs at least a partial distribution function of the force dissipation to the absorbent cushion. The absorbent cushion absorbs the force and transmits it over a large area via the rear side of the membrane. Only tensile force can be transmitted here. This is done over a large area into the frame in which the cushion is held. In an example, the force is transmitted evenly into the frame.

In an example, the absorption filling 32 is designed as an absorption insert that has a material structure with a plurality of cavities. At least a part of the compressive force can be absorbed by elastic and/or plastic deformation of the material structure. The material structure is designed to comprise at least one of the following: foam structure, grid structure, and foam-like fabric.

In a further option, in addition to or as an alternative to the absorption filling, the second side of the envelope is designed as an absorption surface. At least a part of the compressive force can be absorbed by elastic and/or plastic deformation of the absorption surface.

The material structure is characterized by a plurality of relatively small connection areas. These connection areas can be elastically deformed to a certain extent, and they can also be plastic deformed. Due to the plurality of connection areas, a relatively large compressive force acting on the absorption insert can be converted into deformation energy and thus absorbed.

In an example, the material structure can be elastically deformed and returns to its original state after the forces are removed.

In another example, the material structure can be plastically deformed and does not return to its original state after the forces are removed.

In yet another example, the material structure can be deformed elastically and plastically and does not completely return to its original state after the forces have been removed.

Elastic and/or plastic deformation of the material structure converts the impact energy into deformation energy. This reduces the transmission of the impact impulse to the body structure.

In an alternative variant, the absorption body 14 is held by a truss or rib structure. For example, the absorbing mass presses on a surface held by a truss, from which the force is transferred to the truss, which in turn distributes the force evenly to a frame.

In a further alternative variant, the absorption body 14 is designed with a multidimensional rib structure in which forces are diverted from a surface to ribs. The ribs are designed, for example, as a multi-hierarchical grid: small ribs are held by larger ribs, which in turn are held by even larger ribs. The ribs form a grid structure. Through deformation, e.g., elastic and/or plastic, impact energy can be at least partially converted into deformation energy, i.e., at least partially absorbed. For example, a part of the force can be absorbed by a filling, while another part can be absorbed by the grid.

The force that occurs locally during a tail strike is distributed to the frame or ring structure, from where it is transferred to the fuselage.

In an option, the protective insert with the force transmission device is held in a receiving frame, which in turn is sealed in a fuselage structure and designed for pressurization of an interior area of the fuselage. In an example, the tail area in which the protective system is installed is pressurized. In another example, the tail area in which the protective system is installed is not pressurized, but is located in the direction of travel behind a pressure bulkhead that separates a pressurized area from a non-pressurized area.

As a further option, FIG. 2 (as well as FIG. 3 and FIGS. 4-7) shows that the absorption body 14 has a bulgy cross-section shape in the vertical direction.

In an option, the absorption body 14 has a rounded shape in the horizontal direction.

In an example, the absorption body is bulgy. In horizontal direction, the absorption body has a rounded shape.

In another example, the absorption body is not bulgy, but protrudes as a truncated cone, truncated pyramid, or truncated cuboid. In the horizontal direction, the absorption body has a rounded shape.

In an example, the absorption body is bulgy. In horizontal direction, the absorption body has a polygonal or rectangular shape.

In yet another example, the absorption body protrudes as a truncated cone, truncated pyramid, or truncated cuboid and has a polygonal or rectangular shape in horizontal direction.

The term “bulgy” refers to a shape that is convex on both sides, i.e., curved outward. This creates a slightly protruding area on the outside, which ensures that in the event of a tail strike, the force is transferred to the protective insert 10 and the surrounding fuselage areas cannot come into contact with the runway even during different flight maneuvers. On the inside, the shape offers the advantage that external compressive forces can be converted into tensile stress and thus transferred to a frame.

The term “rounded” refers to a shape that allows for the most even distribution of force possible, for example, without sides that meet at an angle. The rounded shape is, for example, circular, oval, elliptical, or egg-shaped, or rounded in a different way.

The absorption body 14 is designed, for example, as a spherical cushion, for example with a lens-shaped cross-section.

The vertical direction refers to a subsequent installation situation or the primary force effect of the impact force. For example, the vertical direction runs transversely to the protective panel. The horizontal direction refers to a subsequent installation situation or the primary force effect of the impact force. For example, the horizontal direction runs parallel to the protective panel 12.

As an option not shown in detail, it is provided that the protective panel 12 comprises a composite material comprising a matrix and reinforcement fibers embedded in the matrix. At least some of the reinforcement fibers comprise S-glass.

The term S-glass refers to a type of glass fiber that is characterized by very high strength, very high stiffness, and a very high melting point. As a rule, S-glass has the highest values for strength, stiffness, and melting point among the glass reinforcement fibers used commercially. S-glass fibers are otherwise used, for example, in lightweight ballistic protection structures.

For example, the reinforcement fibers are designed for high mechanical requirements even at high temperatures.

For example, the reinforcement fibers comprise aluminum silicate glass with magnesium oxide additives.

The protective panel 12 is characterized by high wear resistance. The wear resistance is designed for a wide temperature range, extending from −30° C. to 120° C. or more, for example. The low temperatures are caused, for example, by winter conditions in the area of the runways, but also by the low temperatures during flight operations at normal cruising altitudes, which can cool the external protective panel. The high temperatures are caused by the heat generated by friction, but to a certain extent also by summer conditions and, above all, solar radiation in the area of runways and high surface temperatures occurring there.

As a further option, FIG. 2 shows with a dashed line that the protective insert 10 can have thermal insulation 34, which reduces heat input from the outer protective panel 12 towards the interior of the fuselage.

The term “heat input” here primarily refers to the heat generated by a tail strike on the protective panel.

The term “thermal insulation” refers to a measure that reduces heat transfer to the interior of the fuselage, where, for example, hydrogen tanks may be located. In an example, the thermal insulation 34 is designed with a lower heat transfer coefficient than the absorbing structure. In another example, the thermal insulation 34 has reduced heat radiation. In yet another example, the thermal insulation 34 has targeted heat dissipation to the side into the fuselage structure. In yet another example, the thermal insulation has active cooling.

For example, the thermal insulation 34 is designed as a layer in the protective insert 10.

In another example, the thermal insulation 34 is applied as a layer on the inside of the protective insert 10.

In an option, the thermal insulation 34 is connected to the frame structure that holds the protective insert 10. For example, a ring screw connection of the frame structure allows the heat to be introduced as homogeneously as possible in addition to the holding forces.

In an example, the absorption body 14, which is designed as a cushion, is formed on the outside with a metal wall or metal envelope or metal membrane and on the inside with a thermal insulation wall or envelope of the membrane.

The outside is the side facing outwards, which is covered, for example, by the protective layer. The inside is the side facing the interior of the hull when installed, which is covered, for example, by additional thermal insulation.

In an example, the thermal insulation is formed by the absorption body itself.

In another example, the thermal insulation is integrated with the absorption body.

In yet another example, the thermal insulation is formed as a separate component in addition to the absorption body.

FIG. 3 schematically shows an example of a protective system 100 for a tail area of an aircraft. The protective system 100 has an example of the protective insert 10 according to one of the preceding examples and a receiving frame 102. The receiving frame 102 is configured to receive the protective insert 10 and to transfer the forces acting on the receiving frame 102 via the protective insert 10 to an aircraft fuselage structure. The receiving frame 102 has a receptacle 104 for the protective insert and a plurality of connection points 106 for attachment to supporting elements of the fuselage structure.

The term “protective system” refers to a measure for protecting the fuselage in the event of tail strikes. The protective measure is designed, for example, as a system in which the components are interchangeable.

The term “receiving frame” refers to a holding device for the protective insert. For example, the holding device is designed as a surrounding frame.

In another example, the holding device is designed as a partially surrounding frame.

The receiving frame 102 has, for example, a plurality of connecting tabs for attachment to frames and stringers.

The receiving frame 102 serves to distribute the force as evenly as possible into the fuselage.

According to an aspect, a defined interface is provided for a tail strike protection measure. The receiving frame 102 forms a predetermined connection between the absorbent protective element and the fuselage.

The protective insert is designed to be large enough to cover the possible impact locations at the tail.

In an example, the protective insert can only be inserted into the receiving frame 102 in a predetermined installation direction, which is designed for the expected direction of impact of the tail strike.

In FIG. 3, the protective system 100 is shown in connection with a schematically indicated fuselage construction with an outer skin 110 and a supporting structure 112 of the fuselage located behind it. In addition, a runway 114 is indicated for better understanding. Various forces act when in case of a contact of the protective insert 10, for example during a tail strike. The contact or impact is indicated by a broad arrow 116. A first arrow 118 shows the downward force of gravity acting on the aircraft; a second arrow 120 indicates the direction of flight and a third arrow 122 indicates the frictional force at the contact surface.

In an option of the protective system 100 not shown in detail, the protective insert 10 is held openable when the receiving frame 102 is installed. The receiving frame 102 is designed to form an access opening to the interior of the fuselage when the protective insert 10 is opened or removed for inspection, maintenance, and/or repair purposes.

The term “hold openable” refers to the possibility of opening and closing the protective insert 10. An example is a movably held protective insert 10. Another example is a detachably held protective insert. Detachable means that the mounted protective insert 10 can be removed and then reinstalled.

The protective insert 10 is, for example, a part of a cover or a maintenance flap, so that no actual disassembly is necessary.

In another example, the protective insert 10 is detachable for opening, i.e., removable, so that a temporary disassembly takes place.

The protective insert 10 can be disassembled when the receiving frame 102 is mounted, i.e., fastened. After loosening, the protective insert 10 can be fastened again. The protective insert 10 can therefore be reassembled when the receiving frame 102 is mounted.

The term “access opening” refers to an opening that is designed to allow a person to enter the fuselage area. For example, the access opening is also designed to allow material and tools to be brought in and out through the opening.

The protective insert 10 forms a dual-functional component. On the one hand, it serves as a replaceable component that is designed for optimum protection and can be replaced when worn. On the other hand, it serves as an openable closure for inspection access.

The integration of the protective insert 10, i.e., the function of a protective panel, into an opening maintenance hatch is therefore proposed. The opening maintenance hatch can also be referred to as a “manhole.”

The opening edge is designed to transfer forces into the hull structure.

The protective insert 10 enables the integration of the functions i) access, ii) protection, and iii) damping.

Under normal flight conditions, for example, the protective insert 10 serves as a load-bearing panel, for example to transfer ground loads and forces during flight operation. At the same time, the panel can receive and partially absorb loads when the tail touches down.

For example, the receiving frame 102 is held to the fuselage structure by non-detachable connections, such as rivets. The protective insert 10 is held to the receiving frame 102 by detachable connections.

The removability enables a second function: by removing the protective insert 10, an access opening to the tail area can be provided temporarily, for example for maintenance and repair purposes.

The removability allows the protection to be replaced. For example, the protective insert 10 can be replaced at regular intervals or depending on the frequency or stress of use.

In an example, it is provided that the protective insert 10 can be loosened and removed even in the event of plastic deformation of the absorption body 14 in order to allow access through the opening, for example to reach the hydrogen tanks for inspection purposes.

In an example, the protective system 100 is inserted between two frames. In another example, the length of the protective system 100 when installed is greater than the clear distance between two frames. Therefore, an interruption is inserted into the frames to allow installation of the protective system 100. The interruption forms a kind of frame to divert the ring-shaped forces in the interrupted frame.

A protective measure for tail strikes is proposed that can be easily integrated into existing fuselage designs and can also be implemented with relatively little design effort. Another advantage is the low additional weight. This is particularly important for future propulsion systems, for example, if fuel cells or other propulsion systems and hydrogen tanks are to be installed on board, which have a higher component weight than previous propulsion systems and conventional kerosene tanks. The proposed protective measure for tail strikes contributes to minimizing the weight of the fuselage structure.

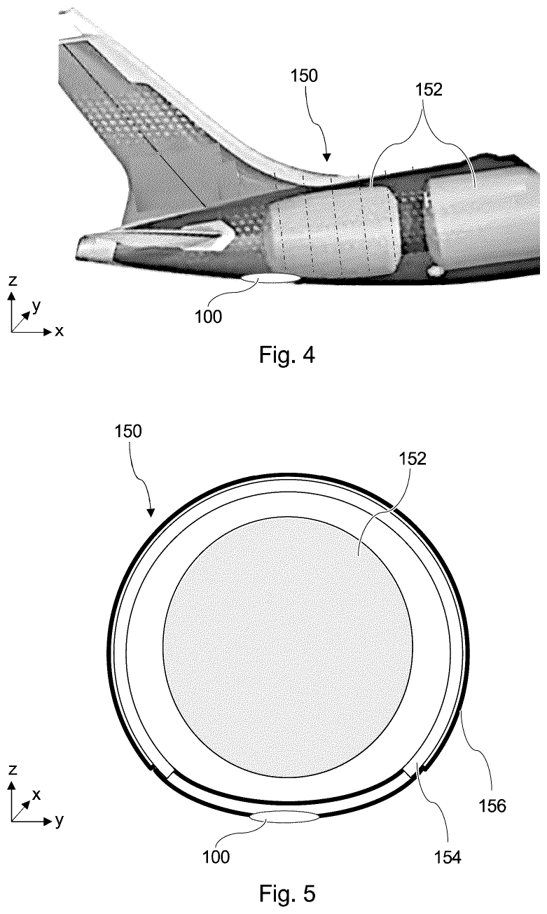

FIG. 4 shows an example of protective system 100 on an aircraft tail 150 in a side view. The aircraft is shown as an example of an aircraft with hydrogen tanks 152. The protective system is located at the rear of the tail on the underside.

FIG. 5 shows the example of the protection system 100 of FIG. 3 in a vertical section through the aircraft tail 150. The aircraft has a schematically represented fuselage structure 154, which comprises, for example, stringers running around the frame and ribs running transversely thereto in the longitudinal direction (not shown in detail). The fuselage structure 154 is covered with an outer skin 156.

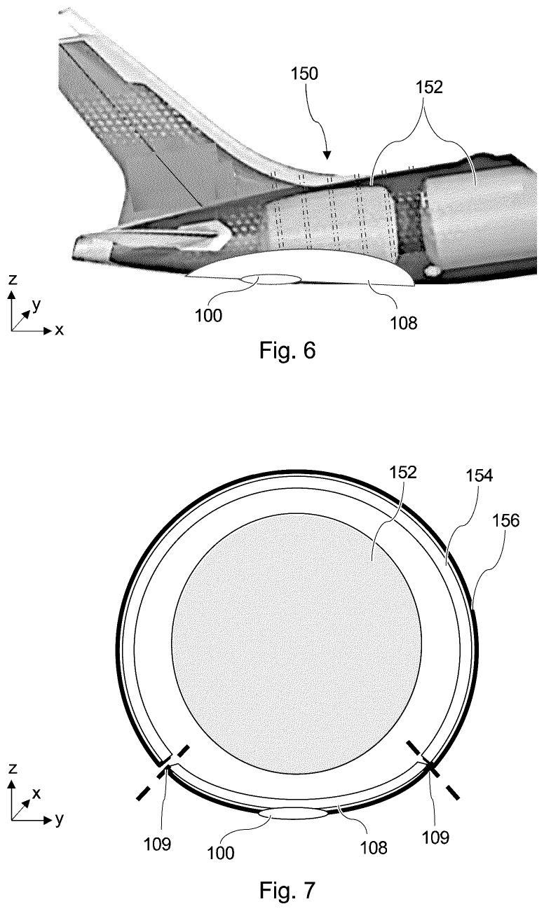

FIG. 6 shows another example of the protection system 100 on another example of the aircraft tail 150 in a side view.

As an option, FIG. 6 and FIG. 7 show that the receiving frame 102 of the protection system 100 is provided in a fuselage panel that is designed as a removable structural panel 108 to enable the installation and removal of larger components, including hydrogen tanks, segments of hydrogen tanks, and systems and components of systems for hydrogen tanks and hydrogen propulsion within the fuselage.

The removable structural panel 108 is connected to the rest of the fuselage structure via defined interfaces 109, for example.

FIG. 7 shows the example of the protection system of FIG. 5 in a vertical section through the rear of the aircraft.

The term “fuselage panel” refers to a plate-like component that is inserted into the fuselage. The fuselage panel may have a curved shape. Its outer shape may be adapted to the course of the load-bearing structural components of a fuselage, i.e., frames and stringers. The fuselage panel has a load-bearing structure, for example similar to the adjacent remaining fuselage areas or fuselage segments. The fuselage panel may also have an outer skin.

The term “structural panel” refers to the load-bearing property of the panel. The fuselage panel is, for example, part of the primary structure of the aircraft.

In a variant, the protective insert is integrated into a fuselage shell, e.g., in combination with the maintenance hatch function. However, for installing and removing larger structures inside the fuselage, such as tanks, the fuselage does not have a large removable panel, but can be opened via a so-called orbital joint. The orbital joint is, for example, a type of detachable connection between two fuselage segments.

As an option, the protective system is designed so that the protective insert is interchangeable and can be used in different aircraft. This requires high precision and low play in the mounting connections, e.g., drill holes. This so-called “interchangeability” offers advantages in maintenance, service, and repairs.

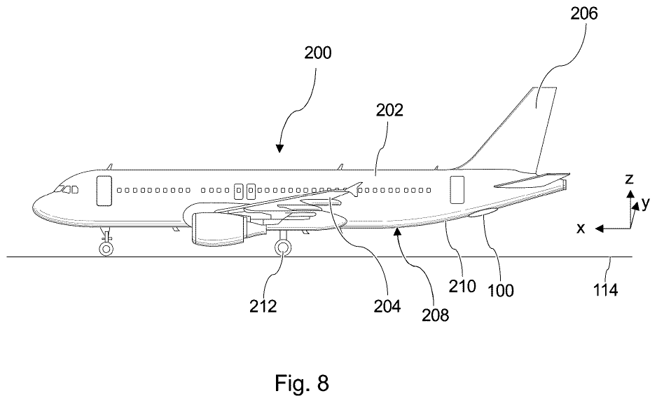

FIG. 8 shows a schematic example of an aircraft 200 in a side view in connection with a runway. The aircraft 200 has a fuselage 202, wings 204 attached to the fuselage, and a tail unit 206 attached to the fuselage. The fuselage has a tail area 208. An example of the protection system 100 according to one of the preceding examples is provided on an underside 210 of the tail area.

The aircraft is shown, for example, with an extended landing gear 212.

The protective system 100 is suitable, for example, for aircraft that are designed with hydrogen tanks in the tail area. Among other things, the damping effect of the protective insert means a reduction in the forces acting on the tank mountings.

In an option, an aircraft fuselage structure is provided. The fuselage structure has a plurality of frames and a plurality of stringers. The frames and stringers are connected to each other and are designed to hold an outer skin to enclose an interior fuselage area. The fuselage structure has a tail area. A protective system according to one of the above examples is provided on an underside of the tail area of the fuselage structure. The protective system transfers an impact force to the fuselage structure in the event of a tail impact. The frames may also be referred to as ribs.

In a practical application, measures are provided to prevent a tail strike, for example by the pilot or by control measures to avoid a tail strike occurring. For example, control interventions may be provided to prevent the aircraft from having an angle too large in relation to a runway when, for example, it takes off, lands, or aborts takeoff.

In an option, a protective insert according to one of the preceding examples is provided, or a protective system according to one of the preceding examples on the underside of an aircraft.

If an undesirable contact between the tail and the runway, i.e., a tail strike, occurs, i.e., despite the other measures, the tail area of the aircraft touches down on a runway during takeoff or landing, at least a part of the absorption body undergoes deformation either in an elastic or plastic manner, and the damped compressive force can be transmitted to the fuselage.

In another option, a use of a protective insert for a tail impact of an aircraft is provided. The protective insert has an external protective panel for pressure-loaded sliding contact with a runway and an absorption body supporting the protective panel. The protective panel transfers a pressure force acting during the tail impact to the absorption body. The absorption body is designed to absorb the pressure force and comprises an absorption insert having a material structure with a plurality of cavities, wherein at least a part of the pressure force is absorbable through elastic and/or plastic deformation of the material structure. The material structure is designed to comprise at least one of the following: foam structure, grid structure, and foam-like fabric.

In another option, a use of a protective insert for a tail impact of an aircraft according to one of the preceding examples is provided.

The embodiments described above can be combined in various ways. In particular, aspects of the devices can also be used for the embodiments of the method and vice versa.

In addition, it should be noted that “comprising” does not exclude other elements or steps, and “a” does not exclude a plurality. It should also be noted that features or steps described with reference to one of the above embodiments may also be used in combination with other features or steps of other embodiments described above. Reference numerals in the claims are not to be considered limiting.

Moreover, throughout this document including the claims, expressions such as “at least one of”, or “one or more of”, when preceding a list of elements, modify the entire list of elements and do not modify the individual elements of the list.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A protective insert for a tail area of an aircraft, the protective insert comprising:
a protective panel;
an absorption body supporting the protective panel; and
a force transmission device holding the absorption body;
wherein the protective panel is configured for pressure-loaded sliding contact with a runway upon a tail impact; and wherein the protective panel transfers a pressure force acting during the tail impact to the absorption body;
wherein the absorption body is configured to absorb a compressive force in a force-damping manner, wherein a portion of an energy due to the acting compressive force can be converted into at least one of an elastic or plastic deformation of at least a portion of the absorption body; and
wherein the force transmission device is configured to hold the protective insert to an underside of the tail area of the aircraft and has a plurality of fastening areas.

2. The protective insert according to claim 1,
wherein the absorption body comprises an absorption insert having a material structure with a plurality of cavities,
wherein at least a part of the energy due to the acting compressive force can be absorbed by at least one of elastic or plastic deformation of the material structure; and
wherein the material structure is formed from at least one of a group comprising:
foam structure;
grid structure; and
foam-like fabric.

3. The protective insert according to claim 1,
wherein the absorption body is formed cushion-like and has an envelope in which a filling is provided;
wherein the envelope is held on the force transmission device and forms a first side against which the protective panel abuts, and a second side facing away from the first side; and
wherein the filling is configured to transfer a compressive force transferred by the protective panel on the first side to the second side of the envelope, so that the force can be transferred via the second side of the envelope as a tensile force to the force transmission device.

4. The protective insert according to claim 1, wherein the filling is configured as an absorption filling and at least a part of the energy due to the acting compressive force can be absorbed by at least one of elastic or plastic deformation of the absorption filling.

5. The protective insert according to claim 4,
wherein the absorption filling is configured as an absorption insert having a material structure with a plurality of cavities, wherein at least a part of the energy due to the acting compressive force can be absorbed by at least one of elastic or plastic deformation of the material structure, and
wherein the material structure is configured as at least one of a group comprising: foam structure, grid structure, and foam-like fabric.

6. The protective insert according to claim 1,
wherein the absorption body has a bulgy cross-section shape in a vertical direction; and
wherein the absorption body has a rounded shape in a horizontal direction.

7. The protective insert according to claim 1,
wherein the protective panel comprises a composite material comprising a matrix and reinforcement fibers embedded in the matrix, and
wherein at least a part of the reinforcement fibers comprise S-glass.

8. The protective insert according to claim 1, wherein the protective insert comprises thermal insulation for reducing heat input from the outer protective panel toward an interior area of an aircraft fuselage.

9. A protective system for a tail area of an aircraft, the protective system comprising:
a protective insert according to claim 1; and
a receiving frame;
wherein the receiving frame is configured to receive the protective insert and to transfer forces acting on the receiving frame via the protective insert into a fuselage of the aircraft; and
wherein the receiving frame has a receptacle for the protective insert and a plurality of connection points for attachment to supporting elements of the fuselage structure.

10. The protective system according to claim 9,
wherein the protective insert is openable when the receiving frame is mounted; and
wherein the receiving frame is configured to form an access opening to the interior of the aircraft fuselage when the protective insert is opened or removed for at least one of inspection, maintenance, or repair purposes.

11. The protective system according to claim 9, wherein the receiving frame is provided in a fuselage panel that is configured as a removable structural panel to enable an installation and removal of larger components, including hydrogen tanks, segments of hydrogen tanks, and systems and components of systems for hydrogen tanks and hydrogen propulsion within the aircraft fuselage.

12. An aircraft comprising:
an aircraft fuselage;
wings attached to the aircraft fuselage; and
a tail unit attached to the aircraft fuselage;
wherein the fuselage has a tail area; and
wherein a protective system according to claim 9 is provided on an underside of the tail area.
